(19) United States
(12) Patent Application Publication
(10) Pub. No.: US 2024/0370533 A1
(43) Pub. Date: Nov. 7, 2024

(54) SYSTEM TO LEVERAGE ACTIVE LEARNING FOR ALERT PROCESSING

(71) Applicant: VMware, Inc., Palo Alto, CA (US)

(72) Inventors: Shelly MEHTA, Sunnyvale, CA (US); Lalit Prithviraj JAIN, Cupertino, CA (US); Raghav BATTA, Livermore, CA (US); Jonathan James OLIVER, Kew (AU)

(21) Appl. No.: 18/313,191

(22) Filed: May 5, 2023

(51) Int. Cl. G06F 21/12; G06F 21/57

(52) U.S. Cl. CPC G06F 21/121; G06F 21/577; G06F 2221/033

(57) ABSTRACT

A machine-learning (ML) platform at which alerts are received from endpoints and divided into a plurality of clusters, wherein a plurality of alerts in each of the clusters is labeled based on metrics of maliciousness determined at a security analytics platform, the plurality of alerts in each of the clusters representing a population diversity of the alerts, and wherein the ML platform is configured to execute on a processor of a hardware platform to: select an alert from a cluster for evaluation by the security analytics platform; transmit the selected alert to the security analytics platform, and then receive a determined metric of maliciousness for the selected alert from the security analytics platform; and based on the determined metric of maliciousness, label the selected alert and update a rate of selecting alerts from the cluster for evaluation by the security analytics platform.

### BACKGROUND

Security operations centers (SOCs) provide services for monitoring computer systems of organizations to detect threats. At SOCs, SOC analysts use various security analytics tools to evaluate security alerts. Such tools include security information and event management (SIEM) software, which includes components for automatically evaluating security alerts and components that enable manual evaluation by SOC analysts. Such tools also include correlation engines, which automatically evaluate alerts. The alerts are contextual and identify values of various features, such values being used for determining whether the alerts were generated in response to malicious activity or harmless activity.

The number of alerts generated by security systems is often too large to effectively monitor the computer systems. For example, the number of alerts may far outweigh the number of alerts that a team of SOC analysts can triage in a timely manner. As a result, the SOC analysts may identify malicious activity too late for remediation measures to be effective. In the case of automatic evaluators such as correlation engines, the number of alerts may be too large for the evaluators to determine malicious activity accurately. A system is needed for communicating alerts to SOCs in a manner that enables faster identification of malicious activity.

### SUMMARY

One or more embodiments provide a machine-learning (ML) platform at which alerts are received from endpoints and divided into a plurality of clusters. A plurality of alerts in each of the clusters is labeled based on metrics of maliciousness determined at a security analytics platform. The plurality of alerts in each of the clusters represents a population diversity of the alerts. The ML platform is configured to execute on a processor of a hardware platform to: select an alert from a cluster for evaluation by the security analytics platform; transmit the selected alert to the security analytics platform, and then receive a determined metric of maliciousness for the selected alert from the security analytics platform; and based on the determined metric of maliciousness, label the selected alert and update a rate of selecting alerts from the cluster for evaluation by the security analytics platform.

Further embodiments include a method of processing alerts as the above ML platform is configured to perform and a non-transitory computer-readable storage medium comprising instructions that cause a computer system to carry out such a method.

### BRIEF DESCRIPTION OF THE DRAWINGS

FIG. 1 is a block diagram of a virtualized computer system in which embodiments may be implemented.

FIG. 2 is a block diagram illustrating components of an ML platform of the virtualized computer system, the ML platform being configured to perform embodiments.

FIG. 3 is a block diagram illustrating alerts that have been generated at endpoints of the virtualized computer system and that have been assigned to clusters.

FIG. 4 is a flow diagram of a method performed by the ML platform to input a selected alert into a machine-learning model to predict a maliciousness value of the alert and to transmit the selected alert to a security analytics platform for evaluation, according to an embodiment.

FIG. 5 is a flow diagram of a method performed by the ML platform to use information received from the security analytics platform to re-train the machine-learning model and to update an active-learning mechanism that is applied to clusters of alerts, according to an embodiment.

### DETAILED DESCRIPTION

Techniques for communicating alerts to a security analytics platform (e.g., an SOC) in a manner that enables faster identification of malicious activity, are described. Alerts are generated at endpoints of a customer environment, the endpoints being either virtual or physical devices. Some of those alerts are generated in response to malicious activity and are referred to herein as “malicious alerts.” Other alerts are generated in response to harmless activity and are referred to herein as “harmless alerts.” However, before those alerts are evaluated at the security analytics platform, the nature of the alerts is unknown.

According to embodiments, before alerts are transmitted to the security analytics platform for evaluation (automatic or manual), the alerts are input into a machine-learning (ML) model. The ML model is trained to predict maliciousness values for each of the alerts. For example, a maliciousness value may be a probability that the alert was generated in response to malicious activity, i.e., the probability that the alert is a malicious alert. Then, an explanation is determined for the ML model's prediction, and the alert is transmitted to the security analytics platform along with the ML model's prediction and the explanation. As alerts are evaluated at the security analytics platform, the evaluations are used to further train the ML model to improve the accuracy of its predictions.

To reduce the number of alerts that are evaluated, active learning is applied to the alerts before inputting alerts into the ML model. The alerts are assigned to clusters based on a feature of the alerts such as the names of command lines that triggered the alerts. As alerts from each of the clusters are evaluated at the security analytics platform, those evaluations are used for labeling the alerts as malicious or harmless. An active-learning mechanism uses those labels to update per-cluster rates for selecting alerts for input into the ML model and evaluation at the security analytics platform (e.g., by security analysts). For example, if a cluster only includes alerts that have been labeled as harmless, the active-learning mechanism decreases the rate of selecting alerts from that cluster.

By applying active learning to the selection of alerts, embodiments more intelligently select alerts for evaluation. The labels of alerts within a cluster provide insight into the nature of other alerts in the cluster, i.e., insight into how likely it is that those other alerts are malicious. Alerts that are likely malicious are prioritized over alerts that are likely harmless, effectively suppressing alerts that are likely harmless. Accordingly, the population of alerts becomes well-understood—even with a relatively small number of labels. Furthermore, the active learning continuously increases the reliability of clustering approaches. For example, alerts in clusters that have a variety of labels are prioritized over alerts in clusters that consistently receive harmless labels. This increases the time that is spent evaluating and labeling alerts that are less predictable in nature, which helps the security analytics platform to identify malicious alerts and apply remediation measures more quickly.

Additionally, by sampling a wide variety of different types of alerts, the active learning ensures to sample alerts that are less prevalent, i.e., that were triggered based on rarely used command lines in addition to common ones. These alerts are then evaluated at the security analytics platform to discover the nature of such alerts. These evaluations provide reliable insights into the nature of different types of alerts, getting better coverage and representation of the overall alert population. Finally, the predictions from the ML model and explanations simplify the evaluations at the security analytics platform (e.g., by security analysts who review them), further decreasing response times. These and further aspects of the invention are discussed below with respect to the drawings.

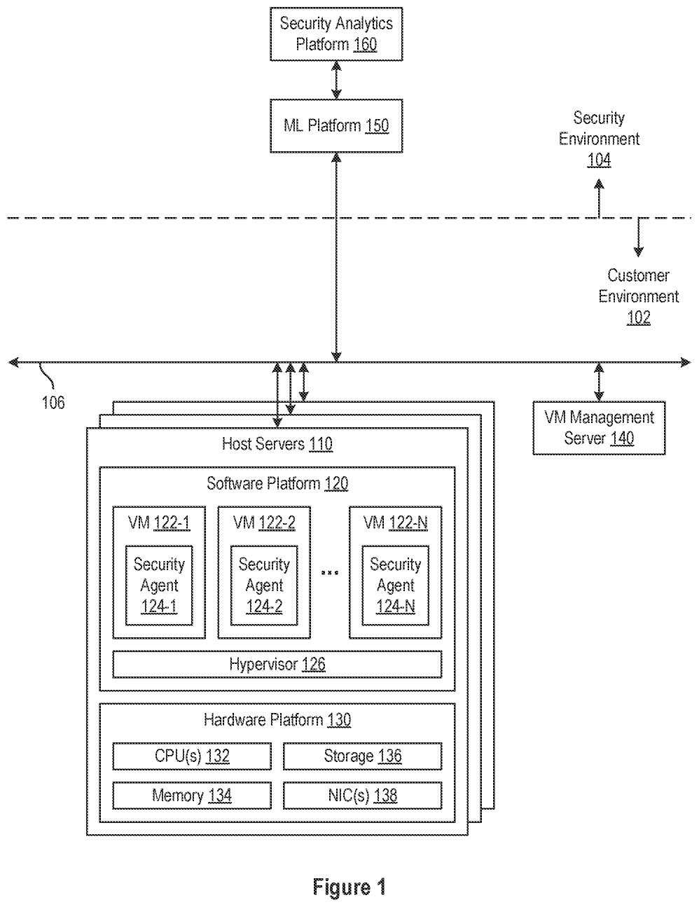

FIG. 1 is a block diagram of a virtualized computer system in which embodiments may be implemented. The virtualized computer system includes a customer environment 102 and an external security environment 104. As used herein, a “customer” is an organization that has subscribed to security services offered through an ML platform 150 of security environment 104. A “customer environment” is one or more private data centers managed by the customer (commonly referred to as “on-premise” data centers), a private cloud managed by the customer, a public cloud managed for the customer by another organization, or any combination of these. Although security environment 104 is illustrated as being external to customer environment 102, any components of security environment 104 may instead be implemented within customer environment 102.

Customer environment 102 includes a plurality of host servers 110 and a virtual machine (VM) management server 140. Each of host servers 110 is constructed on a server-grade hardware platform 130 such as an x86 architecture platform. Hardware platform 130 includes conventional components of a computing device, such as one or more central processing units (CPUs) 132, memory 134 such as random-access memory (RAM), local storage 136 such as one or more magnetic drives or solid-state drives (SSDs), and one or more network interface cards (NICs) 138. Local storage 136 of host servers 110 may optionally be aggregated and provisioned as a virtual storage area network (vSAN). NICs 138 enable host servers 110 to communicate with each other and with other devices over a physical network 106 such as a local area network.

Hardware platform 130 of each of host servers 110 supports a software platform 120. Software platform 120 includes a hypervisor 126, which is a virtualization software layer. Hypervisor 126 supports a VM execution space within which VMs 122 are concurrently instantiated and executed. One example of hypervisor 126 is a VMware ESX® hypervisor, available from VMware, Inc. VMs 122 include respective security agents 124, which generate alerts in response to suspicious activity. Although the disclosure is described with reference to VMs as endpoints of customer environment 102, the teachings herein also apply to nonvirtualized applications and to other types of virtual computing instances such as containers, Docker® containers, data compute nodes, and isolated user space instances for which behavior is monitored to discover malicious activities. Furthermore, although FIG. 1 illustrates VMs 122 and security agents 124 in software platform 120, the teachings herein also apply to security agents 124 implemented in firmware for hardware platform 130.

VM management server 140 logically groups host servers 110 into a cluster to perform cluster-level tasks such as provisioning and managing VMs 122 and migrating VMs 122 from one of host servers 110 to another. VM management server 140 communicates with host servers 110 via a management network (not shown) provisioned from network 106. VM management server 140 may be, e.g., a physical server or one of VMs 122. One example of VM management server 140 is VMware vCenter Server,® available from VMware, Inc.

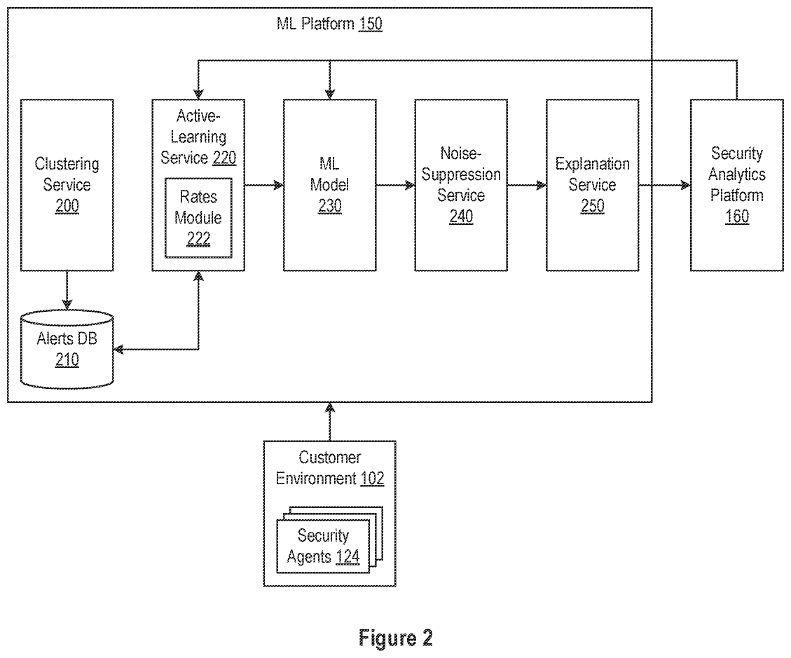

ML platform 150 provides security services to VMs 122. ML platform 150 communicates with VMs 122 over a public network (not shown), e.g., the Internet, to obtain alerts generated by security agents 124. Alternatively, if implemented within customer environment 102, ML platform 150 may communicate with VMs 122 over private networks, including network 106. ML platform 150 includes a variety of services for processing the alerts, as discussed further below in conjunction with FIG. 2. The services of ML platform 150 run in a VM or in one or more containers and are deployed on hardware infrastructure of a public computing system (not shown).

The hardware infrastructure supporting ML platform 150 includes the conventional components of a computing device discussed above with respect to hardware platform 130. CPU(s) of the hardware infrastructure are configured to execute instructions such as executable instructions that perform one or more operations described herein, which may be stored in memory of the hardware infrastructure. For some of the alerts received from VMs 122, ML platform 150 transmits the alerts to a security analytics platform 160 for evaluation. For example, security analytics platform 160 may be an SOC in which security analysts manually evaluate alerts to detect and respond to malicious activity or an SOC in which a correlation engine automatically evaluates alerts.

FIG. 2 is a block diagram illustrating components of ML platform 150, which are configured to perform embodiments. Security agents 124 of customer environment 102 generate alerts based on suspicious activities and transmit those alerts to ML platform 150, e.g., over the Internet. A clustering service 200 divides the alerts into clusters according to a feature of the alerts such as command lines executed at VMs 122 that triggered the alerts. After dividing the alerts into clusters, the alerts are stored in an alerts database (DB) 210. An active-learning service 220 selects alerts from alerts DB 210 for evaluation. The rates at which active-learning service 220 selects alerts from clusters are based on active-learning techniques. Active-learning service 220 stores such rates in a rates module 222.

When active-learning service 220 selects an alert from alerts DB 210, the alert is input into an ML model 230 such as an artificial neural network. ML model 230 is trained to predict a probability of an alert being malicious. Specifically, ML model 230 is trained based on features of past alerts generated by security agents 124 and evaluations of those alerts from security analytics platform 160. For example, features of alerts used for training ML model 230 may include names of processes from command lines that triggered the alerts, indicators of whether reputation services are assigned to the processes, names of folders from which the processes execute (including full file paths), indicators of how prevalent the command lines or processes are (in a particular one of VMs 122, in a particular one of host servers 110, in customer environment 102, or globally), and indicators of whether files associated with the processes are digitally signed.

ML platform 150 optionally includes a noise-suppression service 240, which allows for hard-coding rules for suppressing certain alerts. An administrator may create such rules to avoid certain alerts being transmitted to security analytics platform 160. It is anticipated in advance that alerts matching the rules are generated in response to harmless activity. It is thus desired not to use resources of security analytics platform 160 to analyze such alerts.

ML platform 150 further includes an explanation service 250 for generating an explanation of a prediction by ML model 230. Such an explanation highlights certain features about the alert that caused the prediction such as a process that triggered the alert not being prevalent in customer environment 102. ML platform 150 then transmits the following to security analytics platform 160: the alert, the prediction from ML model 230, and the explanation from explanation service 250. Security analytics platform 160 then evaluates the alert, e.g., a security analyst determining whether the alert is a malicious alert or a harmless alert.

Security analytics platform 160 then transmits that evaluation to ML platform 150. The evaluation is fed back to two places: ML model 230 and active-learning service 220. The evaluation is used by ML model 230 for further training based on the alert and the evaluation. The evaluation is also used by active-learning service 220 to label the alert in alerts DB 210. Active- learning service 220 then updates rates module 222 in response to the new label, as discussed further below.

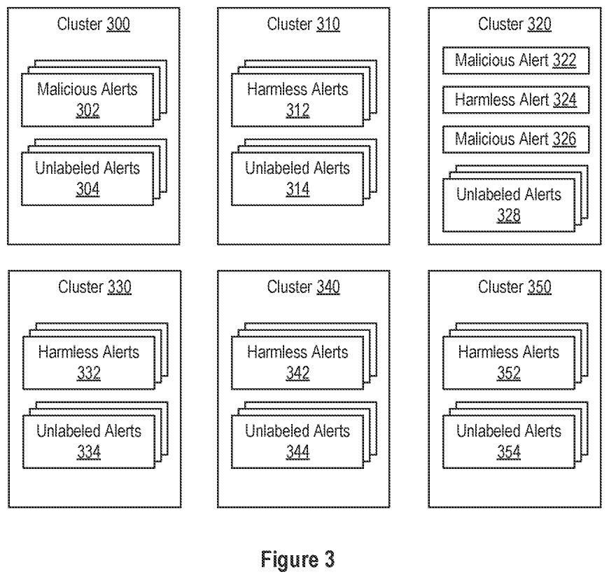

FIG. 3 is a block diagram illustrating alerts that have been generated by security agents 124 and that have been assigned to clusters. For simplicity, FIG. 3 illustrates six clusters. However, alerts DB 210 may include many more clusters. Each of the illustrated clusters includes a plurality of unlabeled alerts: unlabeled alerts 304, 314, 328, 334, 344, and 354 in clusters 300, 310, 320, 330, 340, and 350, respectively. The unlabeled alerts in a cluster often far outnumber the labeled alerts.

At a certain point in time, alerts 302 of cluster 300 have all been labeled as malicious alerts. Based on alerts of cluster 300 consistently being labeled as malicious, it is likely that many of unlabeled alerts 304 are also malicious. This is because unlabeled alerts 304 have similar features to malicious alerts 302, e.g., were generated based on similar command lines. Accordingly, active-learning service 220 maintains a high rate of selecting unlabeled alerts 304 to be input into ML model 230 and evaluated at security analytics platform 160. Malicious alerts are thus discovered more quickly from cluster 300.

Alerts 312 of cluster 310, alerts 332 of cluster 330, alerts 342 of cluster 340, and alerts 352 of cluster 350 have all been labeled as harmless alerts. Based on alerts of these four clusters consistently being labeled as harmless, it is likely that many of unlabeled alerts 314, 334. 344, and 354 are also harmless. Accordingly, active-learning service 220 maintains a low rate of selecting unlabeled alerts 314, 334, 344, and 354 to be input into ML model 230 and evaluated at security analytics platform 160. Alerts from other clusters, which are more likely to be malicious, are prioritized so that malicious alerts are discovered more quickly. Active-learning service 220 may even stop sampling alerts from one of clusters 310, 330, 340, and 350 if that cluster reaches a threshold number of alerts being consistently labeled as indicating harmless activity.

Cluster 320 includes three alerts that have been labeled, alerts 322 and 326, which have been labeled as malicious, and an alert 324, which has been labeled as harmless. Based on there being a mix of differently labeled alerts, there is a reasonable likelihood that some of unlabeled alerts 328 are malicious. Accordingly, active-learning service 220 maintains a high rate of selecting unlabeled alerts 328 to be input into ML model 230 and evaluated at security analytics platform 160. Malicious alerts are thus discovered more quickly from cluster 320.

At a certain point, if there is a cluster for which a relatively small number of alerts have been labeled, active-learning service 220 may increase the rate at which unlabeled alerts are selected from that cluster. This helps to uncover clusters for which there are not enough labels to know with reasonable certainty that alerts therein are harmless. Accordingly, over time, even with a relatively small total number labels, each cluster eventually has enough labels to effectively understand the nature of the cluster. In other words, each cluster eventually has enough labels to know which clusters most likely have malicious unlabeled alerts and which clusters most likely have harmless unlabeled alerts.

Although alerts described herein are only labeled as malicious or harmless, other labeling is possible. There may be any number of categories for labels. Labels may even be a spectrum of values such as a percentage. Regardless of what labeling technique is used, active learning is applied to each cluster to either increase or decrease the rate at which unlabeled alerts are selected from the cluster for evaluation. Because alerts in the same cluster have similar features, the labeled alerts provide insight into the likelihood of unlabeled alerts in the cluster being malicious.

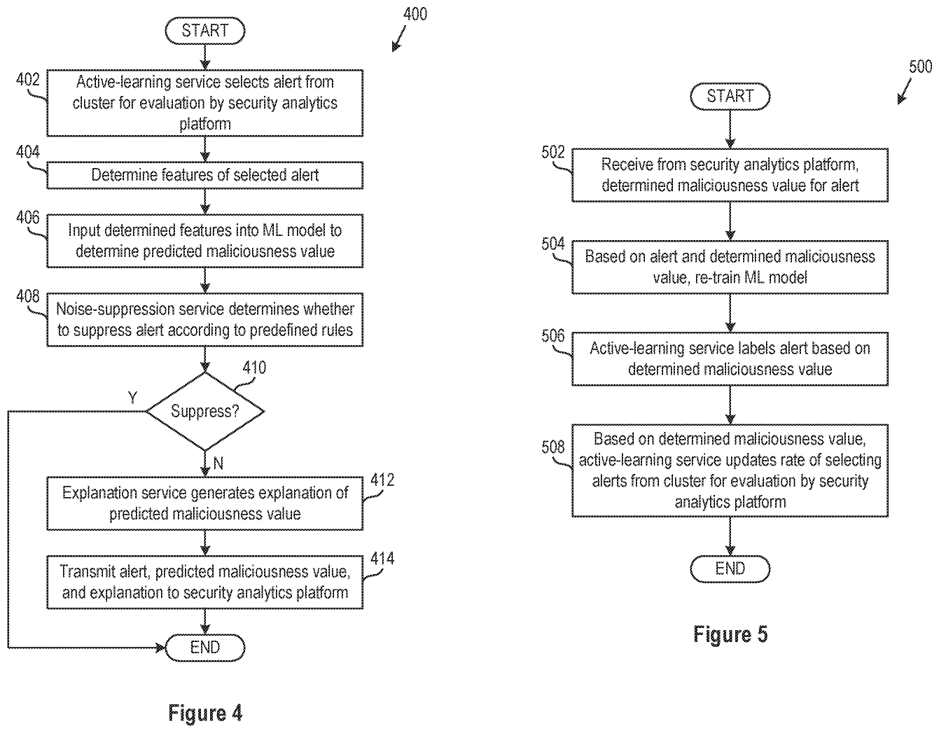

FIG. 4 is a flow diagram of a method 400 performed by ML platform 150 to input a selected alert into ML model 230 to predict a maliciousness value of the alert and to transmit the selected alert to security analytics platform 160 for evaluation, according to an embodiment. Method 400 is performed after a number of alerts have been divided into clusters in alerts DB 210 by clustering service 200. However, security agents 124 continuously generate such alerts, and clustering service 200 continuously assigns those alerts to clusters based on features of the alerts and continuously persists the alerts in alerts DB 210. Additionally, method 400 is performed after ML model 230 has been trained to make predictions of maliciousness values, e.g., probabilities of whether input alerts are malicious. However, even after such an initial training, ML model 230 is continuously trained based on features of alerts and based on evaluations from security analytics platform 160.

At step 402, active-learning service 220 selects an alert from a cluster of alerts DB 210 for evaluation at security analytics platform 160. As mentioned earlier, active-learning service 220 uses rates from rates module 222 to determine rates of selecting alerts from various clusters. Active-learning service 220 prioritizes clusters corresponding to higher rates over clusters corresponding to lower rates. The rates are continuously adjusted as active-learning service 220 labels alerts of alerts DB 210, to prioritize alerts that are likely malicious over alerts that are likely harmless. The cluster that active-learning service 220 samples is a cluster that has not reached a threshold number of alerts being consistently labeled as indicating harmless activity. Accordingly, active-learning service 220 does not have a requisite amount of confidence to predict (assume) that the alert is harmless.

At step 404, ML platform 150 determines features of the selected alert such as those features discussed above (a name of a process from a command line that triggered the alert, an indicator of whether a reputation service is assigned to the process, a name of a folder from which the process executes, an indicator of how prevalent the command line or process is, and an indicator of whether a file associated with the process is digitally signed). At step 406, ML platform 150 inputs the selected alert into ML model 230 (inputs the determined features) to determine a predicted maliciousness value such as a probability of the selected alert being malicious, which is output by ML model 230. ML model 230 predicts the maliciousness value based on the determined features of the selected alert. At step 408, noise-suppression service 240 determines whether to suppress the selected alert according to predefined rules. Step 408 is optionally performed on behalf of an administrator who has determined such predefined rules for suppressing particular alerts that are likely harmless. At step 410, if noise-suppression service 240 determines to suppress the alert, method 400 ends, and that alert is not evaluated at security analytics platform 160.

Otherwise, if noise-suppression service 240 determines not to suppress the alert, method 400 moves to step 412. At step 412, explanation service 250 generates an explanation for the predicted maliciousness value, which highlights certain features about the alert that caused the predicted maliciousness value. For example, if the predicted maliciousness value is a high probability of being malicious, the explanation may state some of the following: a process or command line that triggered the alert not being prevalent (in one of VMs 122, one of host servers 110, in customer environment 102, or globally), a reputation service not being assigned to the process, the process executing from an unexpected folder, a file associated with the process not being digitally signed, and information being missing about a publisher of the digital signature.

Conversely, if the prediction is a low probability of being malicious, the explanation may state some of the following: the process or command line being prevalent, a reputation service being assigned to the process, the process executing from an expected folder, a file associated with the process being digitally signed, and information being present about the publisher of the digital signature. At step 414, ML platform 150 transmits the alert, the predicted maliciousness value, and the explanation to security analytics platform 160 for analysis. After step 414, method 400 ends.

FIG. 5 is a flow diagram of a method 500 performed by ML platform 150 to use an evaluation from security analytics platform 160 to re-train ML model 230 and to update rates module 222, according to an embodiment. At step 502, ML platform 150 receives a determined maliciousness value for an alert from security analytics platform 160, e.g., malicious or harmless. At step 504, based on features of the alert and based on the determined maliciousness value, ML platform 150 re-trains ML model 230. At step 506, active-learning service 220 labels the alert in alerts DB 210 based on the determined maliciousness value, e.g., as malicious or harmless.

At step 508, based on the determined maliciousness value, active-learning service 220 updates rates module 222. Specifically, active-learning service 220 updates the rate of selecting alerts from the cluster for evaluation at security analytics platform 160. For example, if the alert was malicious, active-learning service 220 increases the rate. If the alert was harmless, active-learning service 220 decreases the rate, especially if other alerts from the cluster have consistently been labeled as harmless. After step 508, method 500 ends.

The embodiments described herein may employ various computer-implemented operations involving data stored in computer systems. For example, these operations may require physical manipulation of physical quantities. Usually, though not necessarily, these quantities are electrical or magnetic signals that can be stored, transferred, combined, compared, or otherwise manipulated. Such manipulations are often referred to in terms such as producing, identifying, determining, or comparing. Any operations described herein that form part of one or more embodiments may be useful machine operations.

One or more embodiments of the invention also relate to a device or an apparatus for performing these operations. The apparatus may be specially constructed for required purposes, or the apparatus may be a general-purpose computer selectively activated or configured by a computer program stored in the computer. Various general-purpose machines may be used with computer programs written in accordance with the teachings herein, or it may be more convenient to construct a more specialized apparatus to perform the required operations. The embodiments described herein may also be practiced with computer system configurations including hand-held devices, microprocessor systems, microprocessor-based or programmable consumer electronics, minicomputers, mainframe computers, etc.

One or more embodiments of the present invention may be implemented as one or more computer programs or as one or more computer program modules embodied in computer-readable media. The term computer-readable medium refers to any data storage device that can store data that can thereafter be input into a computer system. Computer-readable media may be based on any existing or subsequently developed technology that embodies computer programs in a manner that enables a computer to read the programs. Examples of computer-readable media are magnetic drives, SSDs, network-attached storage (NAS) systems, read-only memory (ROM), RAM, compact disks (CDs), digital versatile disks (DVDs), magnetic tapes, and other optical and non-optical data storage devices. A computer-readable medium can also be distributed over a network-coupled computer system so that computer-readable code is stored and executed in a distributed fashion.

Although one or more embodiments of the present invention have been described in some detail for clarity of understanding, certain changes may be made within the scope of the claims. Accordingly, the described embodiments are to be considered as illustrative and not restrictive, and the scope of the claims is not to be limited to details given herein but may be modified within the scope and equivalents of the claims. In the claims, elements and steps do not imply any particular order of operation unless explicitly stated in the claims.

Virtualized systems in accordance with the various embodiments may be implemented as hosted embodiments, non-hosted embodiments, or as embodiments that blur distinctions between the two. Furthermore, various virtualization operations may be wholly or partially implemented in hardware. For example, a hardware implementation may employ a look-up table for modification of storage access requests to secure non-disk data. Many variations, additions, and improvements are possible, regardless of the degree of virtualization. The virtualization software can therefore include components of a host server, console, or guest operating system (OS) that perform virtualization functions.

Boundaries between components, operations, and data stores are somewhat arbitrary, and particular operations are illustrated in the context of specific illustrative configurations. Other allocations of functionality are envisioned and may fall within the scope of the invention. In general, structures and functionalities presented as separate components in exemplary configurations may be implemented as a combined component. Similarly, structures and functionalities presented as a single component may be implemented as separate components. These and other variations, additions, and improvements may fall within the scope of the appended claims.

What is claimed is:

1. A machine-learning (ML) platform at which alerts are received from endpoints and divided into a plurality of clusters, wherein a plurality of alerts in each of the clusters is labeled based on metrics of maliciousness determined at a security analytics platform, the plurality of alerts in each of the clusters representing a population diversity of the alerts, and wherein the ML platform is configured to execute on a processor of a hardware platform to:
select an alert from a cluster for evaluation by the security analytics platform;
transmit the selected alert to the security analytics platform, and then receive a determined metric of maliciousness for the selected alert from the security analytics platform; and
based on the determined metric of maliciousness, label the selected alert and update a rate of selecting alerts from the cluster for evaluation by the security analytics platform.

2. The ML platform of claim 1, wherein the selected alert is labeled to indicate malicious activity, and the rate of selecting alerts from the cluster is increased.

3. The ML platform of claim 1, wherein the selected alert is labeled to indicate harmless activity, and the rate of selecting alerts from the cluster is decreased.

4. The ML platform of claim 1, further configured to:
input the selected alert into a trained machine-learning (ML) model to determine a predicted metric of maliciousness for the selected alert; and
re-train the ML model based on the selected alert and the determined metric of maliciousness.

5. The ML platform of claim 4, further configured to:
determine features of the selected alert, wherein inputting the selected alert into the trained ML model includes inputting each of the determined features into the trained ML model.

6. The ML platform of claim 5, wherein the determined features include at least one of: a name of a process from a command line that triggered the selected alert, an indicator of whether a reputation service was assigned to the process, a name of a folder from which the process executes, an indicator of a prevalence of the command line or process, and an indicator of whether a file associated with the process was digitally signed.

7. A method of processing alerts generated by security agents installed at endpoints, wherein the alerts are divided into a plurality of clusters, and a plurality of alerts in each of the clusters is labeled based on metrics of maliciousness determined at a security analytics platform, the plurality of alerts in each of the clusters representing a population diversity of the alerts, the method comprising:
selecting an alert from a cluster for evaluation by the security analytics platform;
inputting the selected alert into a trained machine-learning (ML) model to determine a predicted metric of maliciousness for the selected alert;
transmitting the selected alert and the predicted metric of maliciousness to the security analytics platform, and then receiving a determined metric of maliciousness for the selected alert from the security analytics platform;
re-training the ML model based on the selected alert and the determined metric of maliciousness; and
based on the determined metric of maliciousness, labeling the selected alert and updating a rate of selecting alerts from the cluster for evaluation by the security analytics platform.

8. The method of claim 7, wherein the selected alert is labeled to indicate malicious activity, and the rate of selecting alerts from the cluster is increased.

9. The method of claim 7, wherein the selected alert is labeled to indicate harmless activity, and the rate of selecting alerts from the cluster is decreased.

10. The method of claim 7, further comprising:
determining features of the selected alert, wherein inputting the selected alert into the trained ML model includes inputting each of the determined features into the trained ML model.

11. The method of claim 10, wherein the determined features include at least one of: a name of a process from a command line that triggered the selected alert, an indicator of whether a reputation service was assigned to the process, a name of a folder from which the process executes, an indicator of a prevalence of the command line or process, and an indicator of whether a file associated with the process was digitally signed.

12. The method of claim 10, further comprising:
generating an explanation that includes at least one of the determined features, the at least one of the determined features being a cause of the predicted metric of maliciousness; and
transmitting the explanation to the security analytics platform along with the selected alert and the predicted metric of maliciousness.

13. The method of claim 7, wherein the alerts are divided into the clusters based on command lines that triggered the alerts.

14. A non-transitory computer-readable medium comprising instructions that are executable in a computer system, wherein the instructions when executed cause the computer system to carry out a method of processing alerts generated by security agents installed at endpoints, wherein the alerts are divided into a plurality of clusters, and wherein a plurality of alerts in each of the clusters is labeled based on metrics of maliciousness determined at a security analytics platform, the plurality of alerts in each of the clusters representing a population diversity of the alerts, the method comprising:
selecting an unlabeled alert from a cluster for evaluation by the security analytics platform, wherein the cluster has not reached a threshold number of alerts being consistently labeled as indicating harmless activity;
inputting the selected alert into a trained machine-learning (ML) model to determine a predicted metric of maliciousness for the selected alert;
transmitting the selected alert and the predicted metric of maliciousness to the security analytics platform, and then receiving a determined metric of maliciousness for the selected alert from the security analytics platform;
re-training the ML model based on the selected alert and the determined metric of maliciousness; and
based on the determined metric of maliciousness, labeling the selected alert and updating a rate of selecting alerts from the cluster for evaluation by the security analytics platform.

15. The non-transitory computer-readable medium of claim 14, wherein the selected alert is labeled to indicate malicious activity, and the rate of selecting alerts from the cluster is increased.

16. The non-transitory computer-readable medium of claim 14, wherein the selected alert is labeled to indicate harmless activity, and the rate of selecting alerts from the cluster is decreased.

17. The non-transitory computer-readable medium of claim 14, the method further comprising:
determining features of the selected alert, wherein inputting the selected alert into the trained ML model includes inputting each of the determined features into the trained ML model.

18. The non-transitory computer-readable medium of claim 17, wherein the determined features include at least one of: a name of a process from a command line that triggered the selected alert, an indicator of whether a reputation service was assigned to the process, a name of a folder from which the process executes, an indicator of a prevalence of the command line or process, and an indicator of whether a file associated with the process was digitally signed.

19. The non-transitory computer-readable medium of claim 17, the method further comprising:
generating an explanation that includes at least one of the determined features, the at least one of the determined features being a cause of the predicted metric of maliciousness; and
transmitting the explanation to the security analytics platform along with the selected alert and the predicted metric of maliciousness.

20. The non-transitory computer-readable medium of claim 14, wherein the alerts are divided into the clusters based on command lines that triggered the alerts.
